(19) United States
(12) Patent Application Publication
(10) Pub. No.: US 2003/0051061 A1
(43) Pub. Date: Mar. 13, 2003

(54) Acceptance filter

(76) Inventors: Peter Hank, Hamburg (DE); Hartmut Habben, Hamburg (DE)

Correspondence Address: U.S. Philips Corporation, 580 White Plains Road, Tarrytown, NY, 10591, US

(21) Appl. No.: 10/233,460

(22) Filed: Sep. 3, 2002

(30) Foreign Application Priority Data
Sep. 4, 2001 (DE) 10143356.5

(51) Int. Cl. G06F 15/16

(52) U.S. Cl. 709/250

(57) ABSTRACT

An acceptance filter (1) according to the invention for filtering identifiers in messages which may be exchanged between users (2, 3, 4) over a data bus takes the form solely of a hardware circuit and is provided jointly for the allocated users (2, 3, 4). An identifier received by an allocated user (2, 3, 4) is compared locally with stored identifiers and examined to see whether the message to which the received identifier belongs is relevant to the allocated user (2, 3, 4) that received it and where appropriate a corresponding acceptance signal is sent to this allocated user (2, 3, 4).

In data bus systems, for example in a CAN data bus system, messages are exchanged between users. These messages are distinguished by identifiers, by means of which the users may establish whether a message sent over the data bus is intended for them. Only if this is the case is the message fully received or further processed locally and/or saved.

In order to establish whether a message or its identifier is intended for a receiving user, so-called acceptance filters are known from the prior art, which compare a received identifier with locally stored identifiers. Only if the received identifier is identical with a locally stored identifier does the above-mentioned processing of the message or indeed even complete reception of the message take place. The number of possible identifiers may be very great and the search for such an identifier may therefore require a not insignificant period of time. Prior-art solutions to this problem used both hardware and software-based methods of comparing the received identifiers with those stored locally.

The problem with these solutions is that messages are transmitted over the data bus only during a relatively short period, but it has to be determined within this period whether or not a particular user wants to receive the message with the sent identifier. Therefore, the time available to search for the identifier is relatively short.

It is an object of the invention to provide an acceptance filter which operates as quickly as possible and may be used simultaneously for a plurality of allocated users.

This object is achieved according to the invention by the features of claim 1:

An acceptance filter for filtering identifiers in messages which may be exchanged between users over a data bus, wherein the acceptance filter takes the form solely of a hardware circuit, is provided jointly for a plurality of allocated users, examines every identifier received by an allocated user by comparing it with locally stored identifiers to see whether the message with which the received identifier is associated is relevant to the allocated user that received it and, where appropriate, sends a corresponding acceptance signal to this allocated user.

The acceptance filter according to the invention uses solely a hardware circuit for comparing a received identifier with locally stored identifiers. This dedicated hardware circuit may operate more quickly than is the case with solutions known from the prior art. Therefore, it is also possible according to the invention to allocate a plurality of users to the acceptance filter. The acceptance filter comes into action when one of the allocated users receives a message or the start of a message with an identifier. The acceptance filter then compares the received identifier with locally stored identifiers and examines whether the received identifier is relevant to the allocated user that has received it. This is done by comparing the received identifier with locally stored identifiers assigned to the allocated user. If the acceptance filter establishes that the received identifier is identical with one of these identifiers stored locally and assigned to the user that has received it, the acceptance filter sends an appropriate message to the relevant user.

If the relevant user receives such an acceptance signal, that user then knows that the message with which the identifier is associated is intended for it and receives said message completely or subjects it to further processing. If the user does not receive such an acceptance signal, it rejects the message or does not receive the message.

The structure and mode of operation of the acceptance filter allow it to operate relatively quickly and thus to be used for a plurality of allocated users, wherein it is still ensured that each of the allocated users receives any acceptance signal in good time such that it is still in a position to receive the message completely.

This is achieved in particular in that the acceptance filter is wholly a hardware component. To this end, the layout according to a development of the invention as claimed in claim 2 may in particular be provided. This structure allows a relatively quick comparison to be effected between a received identifier and locally stored identifiers.

The hardware circuit as claimed in claim 2 advantageously operates in detail as described in claim 3. In a nutshell, the received identifier, which is transmitted by the allocated user to the acceptance filter, is compared with locally stored identifiers, stored in an identifier memory, by means of a comparator. The locally stored identifiers are addressed by means of an acceptance filter control system, wherein this addressing is modified until a match is found by means of the comparator or until all locally stored identifiers have been searched through. If a match is found, the control system sends the acceptance signal to the allocated user that has received the identifier.

For this search it may be advantageous, as provided according to a further development of the invention as claimed in claim 4, to use a so-called binary search algorithm. With such a binary search algorithm, the search range is redefined in each search procedure. All locally stored identifiers are stored together with numbers belonging to the allocated users. First of all, the user numbers are stored in ascending order in the identifier memory. Within the number areas of the individual users, the identifiers are themselves stored in ascending order.

At the beginning of such a binary search procedure, first of all the entire memory area is looked at and defined as a search range. Approximately in the middle of the search range, a user number with identifier is addressed by the control system and a corresponding comparison with the received identifier and the number of the allocated user takes place. If this comparison is positive, i.e. the two numbers and identifiers are identical, an identifier has thus already been found and a corresponding acceptance signal may be sent to the allocated user. If they are not identical, it is established whether the received identifier is greater or smaller than the addressed identifier. If it is greater, a new search range is defined which comprises the upper half of the address range whereas, if it is smaller, a new search range is defined which comprises the lower half of the old search range. In each case, therefore a new search range is defined which is approximately half the size of the previous one. In the new search range, a middle value is again compared with the received identifier and the number of the allocated user. If these are identical a searched-for identifier is found again, while otherwise the search range is again re-divided in which the search range obtained in the second step is again divided and a new search range above or below the value addressed in the second search step takes place depending on whether the received identifier was greater or smaller than the most recently addressed comparison value. This procedure continues until the entire address range, i.e. all the locally stored identifiers with allocated user numbers, has been searched through. If this search is fruitless, i.e. no match is found, the received message is not intended for the allocated user. If, however, a match is found indeed, a corresponding acceptance signal is sent to the allocated user and the search process is stopped.

In order to further accelerate the search process, it may be advantageous, as provided according to a further development of the invention as claimed in claim 5, to make a comparison of the received identifier with only those locally stored identifiers which exhibit the same length. Identifiers of different bit lengths may optionally be provided in a data bus. If the local comparison is made only with those identifiers which exhibit the same bit length as the received identifier, this shortens the search process still further.

For the purpose of further simplification, at least some of the locally stored identifiers, as is provided according to a further embodiment of the invention as claimed in claim 6, may be stored not explicitly with their numbers but rather as a range of identifier numbers. If a received identifier lies within a stored identifier number range, a match is again present and an acceptance signal is sent to the receiving user.

The comparison of a received identifier, as is provided according to a further embodiment of the invention as claimed in claim 7, may advantageously be performed in such a way that firstly a comparison is performed with the explicitly stored identifiers and then a comparison with the identifier ranges.

If a plurality of allocated users simultaneously or virtually simultaneously receives new identifiers, these are processed, as is provided according to a further embodiment of the invention as claimed in claim 8, in the order of precedence of the allocated users determined by their numbers. It may be ensured, for example, that even under very difficult conditions, i.e. if for example a plurality of allocated users receives a plurality of messages more or less at the same time, the acceptance filter gives priority to the most important users having the highest priority, so that, for these users having the high priority, acceptance signals may, where appropriate, in all cases be sent to the users in good time.

The invention will be further described with reference to an example of embodiment shown in the drawings, to which, however, the invention is not restricted. In the Figs.:

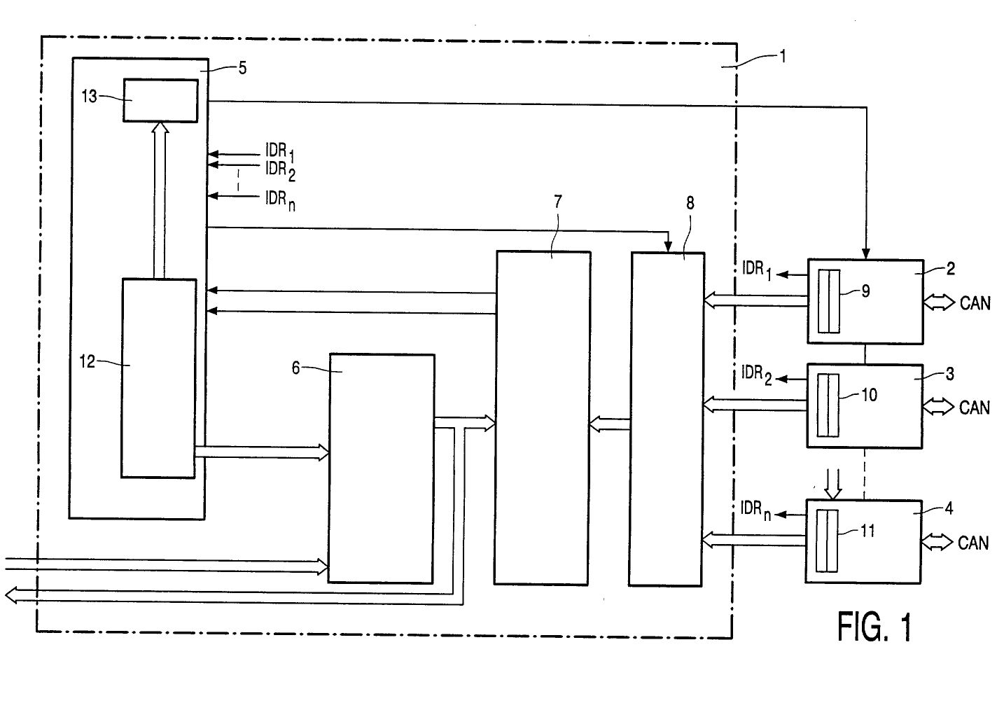

FIG. 1 shows a block diagram of an acceptance filter according to the invention with a plurality of allocated users and

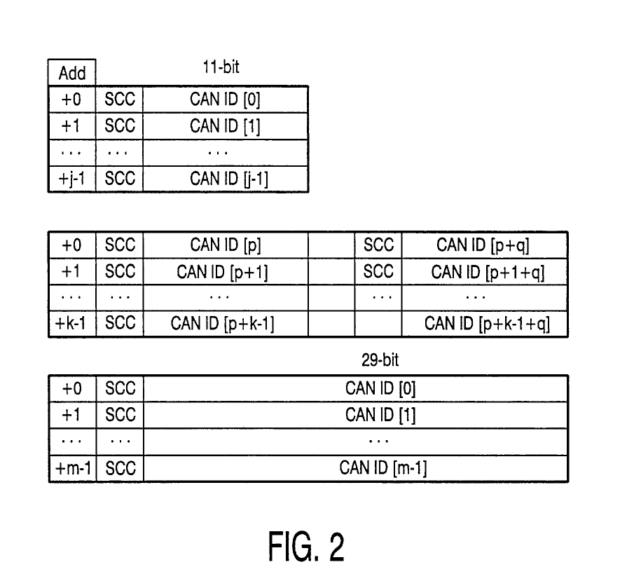

FIG. 2 is a schematic representation of a memory area of locally stored user numbers and identifiers, as may be stored for example in the identifier memory of the acceptance filter according to FIG. 1.

FIG. 1 is a block diagram of an acceptance filter 1 according to the invention, to which a plurality of users in a data bus system are allocated. For the sake of simplicity, FIG. 1 shows three users 2, 3 and 4; it goes without saying that more users may optionally be provided. The allocated users 2, 3 and 4 are users of a CAN data bus and exchange messages over this data bus, which messages may naturally also come from other users which are not shown in the Figure or be sent to them.

A user number is allocated to each of the users 2, 3 and 4. In the example according to the Figure, number 1 is allocated to user 2, number 2 to user 3 and number n to user 4.

Each message transmitted over the CAN data bus, which is not shown in any more detail in the Figure, includes a so-called identifier at the start. The identifier consists of a number sequence, which signals to a receiving user whether or not the message to which the identifier belongs is intended for that user. For the receiving user, this means that it has to compare the identifier that it has received with locally stored identifiers in order to establish whether there is a match and as a consequence whether the received message is intended for that user.

Since this comparison requires a certain amount of time, but on the other hand the time available is limited, as it has to be established within the transmission period of a message whether or not the user is going to receive the message, the acceptance filter 1 according to the invention is provided jointly for the allocated users 2, 3 and 4 and checks to see whether identifiers received thereby are stored locally in relation to the respective allocated user, i.e. whether the identifier which signals a message is one intended for the respective allocated user 2, 3 or 4.

To make this possible, the acceptance filter 1 according to the invention is wholly a hardware component, i.e. all the elements of the acceptance filter 1 explained below are solely hardware circuits, which operate without software, processors or the like.

The acceptance filter 1 comprises a control system 5, likewise a wholly hardware component, which controls the other elements of the acceptance filter 1 with a comparison of the identifiers.

The acceptance filter 1 further comprises an identifier memory 6, in which the numbers of the allocated users 2, 3 and 4 are stored and in which the allocated identifiers for the respective numbers are stored, i.e. those identifiers allocated to a user with the respective number.

Within the acceptance filter 1 there is additionally provided a comparator 7, by which a received identifier and the number of the allocated user may be compared with the values stored in the identifier memory.

The respectively received identifier is in each case supplied to the comparator 7 by means of a multiplexer 8 by the user 2, 3 or 4 that has received it.

FIG. 2 is a schematic representation of the data stored in the identifier memory 6.

In the first column, the representation according to FIG. 2 shows the memory addresses of the respective data records. The data records firstly contain a number SCC belonging to the allocated user. In the second column of the first and third blocks identifier numbers are located, which are allocated to the respective memory with the SCC. These are the identifier numbers which are prefixed to such messages as the respective user is intended to receive with the relevant number. In the schematic representation according to FIG. 2, the first and third blocks exhibit different lengths, since identifiers of two different lengths are provided in this example of embodiment. The identifiers in the first block are 11 bits in length, while those in the third block are 29 bits in length. All the data records comprising user number and identifier are stored in numerically ascending order.

The second block of the schematic representation according to FIG. 2 exhibits identifier ranges. Here, a range of allocated identifiers is stored in each case for a user with a particular number (SCC). If a received identifier with number lies within an identifier range stored in this second block, said identifier belongs to a message which the user is intended to receive. By selecting such identifier ranges, memory space may be saved in the identifier; the search procedure may, however, also be shortened thereby.

It goes without saying that the representation according to FIG. 2 merely shows an example of embodiment; identifiers of other lengths may also be provided and an area may of course just as readily be provided for storing identifier ranges containing identifiers of 29 bit length. In any case, all the data records comprising user number and identifier are stored in numerically ascending order.

The mode of operation of the acceptance filter according to the invention is explained below with reference to the block diagram of FIG. 1 and the schematic representation of the allocated users and the respectively allocated identifiers according to FIG. 2 stored in the identifier memory 6 of the circuit according to FIG. 1.

If an allocated user 2, 3 or 4 of the representation according to FIG. 1 receives a message, or more precisely the start of a message, with an identifier, the user sends this identifier via a buffer 9, 10 or 11 provided therein to the multiplexer 8 of the acceptance filter 1. At the same time, the relevant allocated user sends a signal IDR₁, IDR₂ or IDRₙ to the control system 5 of the acceptance filter 1. In this way, it is made known to the control system that one of the allocated users 2, 3 or 4 has received an identifier. It is also made known to the control system 5 which of these users it is, with which number. The control system 5 accordingly addresses the multiplexer 8 so that the identifier of the relevant user is switched through to the comparator 7.

The control system additionally generates an address by means of an address generator 12 which address is forwarded to the identifier memory 6 and addresses a stored data record therein. This data record arrives at a further input of the comparator 7.

The comparator 7 compares the data supplied by the identifier memory 6 with the data coming from the multiplexer 8. In both cases, this includes the number of the user as well as an identifier number.

For reasons of simplicity, it will initially be assumed below that only identifiers of a fixed length are stored in the identifier memory 6 and that no identifier ranges are stored in the memory 6.

In such a case, all the identifiers and the respectively allocated numbers of the users 2, 3 and 4 are stored in the identifier memory 6. These data records are stored in such a way that they are stored in ascending order, first of all by user number and, within the user numbers, by identifier number. Thus, the first data records to be found in the identifier memory 6 are for example those belonging to the user 1, wherein the identifiers for the user 1 are in turn stored in ascending numerical order. These are followed by the identifiers of the user with the number 2, the identifier numbers again being stored in ascending order. This is continued for all allocated users.

The object of the search or the comparison of a received identifier with the identifiers stored in the identifier memory 6 is therefore to establish whether the station which has received the identifier is to be found in the list stored in the identifier memory 6. If such a match is found, the received message is intended for the allocated user with the relevant number and should therefore be received thereby. If this is the case, the control system 8 sends a corresponding acceptance signal by means of an acceptance signal generator 13 to the allocated user 2, 3 or 4 that has received the identifier.

The above-described arrangement of the data records in the identifier memory 6 is provided in order to shorten this search procedure. A so-called binary search algorithm is advantageously used for the search in the acceptance filter 1 according to the invention. In such a binary search algorithm, the search range is decreased with each search step, wherein the search range is in each case halved in size.

As described above, if one of the allocated users 2, 3 or 4 receives an identifier, the number of the receiving user and the identifier itself are sent to the comparator 7 by means of the multiplexer 8. If a binary search algorithm is used, the address generator 12 within the control system 5 firstly addresses the identifier memory 6 in such a way that, first of all, a data record comprising user number and identifier number is addressed which is located in the middle of the overall memory area in which the data records are stored as described above. The numbers of the receiving user and the received identifier are then compared with these stored numbers in the comparator 7. If a match is found, the comparator 7 sends a corresponding signal to the control system 5. A match means that both the user number and the identifier number are identical. This means that the received message is intended for the user that has received it and that said user should therefore receive the message. The acceptance signal generator 13 then sends a corresponding signal to the respective allocated user 2, 3 or 4 that has received this identifier. If, however, no match is established upon comparison, the comparator 7 sends a signal to the control system 5 which signals whether the number of the receiving user and the number of the received identifier are greater or smaller than the values addressed in the identifier memory 6. If the two values are greater, then a new search range is defined which comprises that address range in the identifier memory 6 which is above the data record addressed in the last search step. If the values are smaller, then the lower data record area in the identifier memory 6 beneath the data record addressed in the last search step is defined as the new search range.

Thus, after a negative comparison result, the search range of the previous comparison step is virtually halved in the next comparison step and that search range is defined as the new search range in which, on the basis of the comparison result, the searched user number and identifier number values are to be expected.

In the new, approximately halved search range, a new data record comprising user number and identifier number is addressed again in the middle of the search range of the identifier memory 6 and the above-described comparison procedure is repeated by means of the comparator 7. If once again no match is found, this second, already halved search range is again halved, wherein the same criterion for selecting the new search range is selected as in the first step.

In this way, it is achieved that the search range is halved in each search step, so that the search is accelerated relative to an ordinary comparison.

The search operation with the ever smaller search ranges is continued until a match is found between the number of the receiving user and the received identifier number and the values addressed in the identifier memory 6. As soon as this is the case, an acceptance signal is sent in the above-described way to the allocated user that has received the identifier.

Owing, on the one hand, to the fact that the acceptance filter is wholly a hardware component and, on the other hand, to the binary search algorithm, the acceptance filter 1 is in a position very quickly to effect a comparison of a received identifier and the allocated user number with the locally stored values and thus to communicate very quickly to the receiving user whether or not the message with the received identifier is intended for that user. This being so, the acceptance filter 1 according to the invention may be used for a plurality of users at the same time.

In the explanation of the comparison procedures, it was assumed that only identifiers of a fixed length and no identifier ranges have been stored in the acceptance filter.

As has already been explained with reference to FIG. 2, however, identifiers of different lengths and optionally identifier ranges may also be stored, as FIG. 2 shows.

In such a case, the above-described binary search operation may be modified as follows:

First of all the length of a received identifier is established. The first search range is then fixed from the outset in such a way that it comprises only the memory areas of the identifier memory 6 which contain identifiers of the received length. If no identifier is found within this range with the above-described binary search, memory areas are searched through which contain ranges of identifiers of the same length as the received identifier.

In other words, the above-described search operation initially takes place in the areas of the identifier memory in which identifiers of the same length are explicitly stored and then continues in the areas in which ranges of identifiers of the appropriate length are stored. Memory areas in which identifiers of another length or ranges of identifiers of another length are stored are not searched.

In this way, the search procedure may be further accelerated.

1. An acceptance filter (1) for filtering identifiers in messages which may be exchanged between users (2, 3, 4) over a data bus, in which the acceptance filter (1) takes the form solely of a hardware circuit, is provided jointly for a plurality of allocated users (2, 3, 4), then examines every identifier received by an allocated user (2, 3, 4) via a comparison with locally stored identifiers to see whether the message to which the received identifier belongs is relevant to the allocated user (2, 3, 4) that received it, and, where appropriate, sends a corresponding acceptance signal to this allocated user (2, 3, 4).

2. An acceptance filter as claimed in claim 1, characterized in that the acceptance filter (1) comprises a control system (5) which is wholly a hardware component, an identifier memory (6), a comparator (7) and a multiplexer (8).

3. An acceptance filter as claimed in claim 2, characterized in that an allocated user (2, 3, 4) sends an identifier receive message to the control system (5) after receipt of an identifier, whereupon the control system (5) supplies the received identifier to the comparator (7) by means of the multiplexer (8) and addresses the identifier memory (6), so that a comparison is performed by means of the comparator (7) of an addressed, stored identifier and the received identifier, while addressing is modified either until a comparison with all stored identifiers has taken place or until a match is found between an addressed, stored identifier and the received identifier, and in that, after such a match has been found, the control system (5) sends an acceptance signal to the allocated user (2, 3, 4) that has received the message with the identifier in the event of messages with this identifier being intended for the relevant allocated user (2, 3, 4).

4. An acceptance filter as claimed in one of claims 1 to 3, characterized in that, for the comparison of a received identifier and the number of the allocated receiving user (2, 3, 4) with numbers of the allocated users (2, 3, 4) stored locally in numerically ascending order and identifiers stored within the number areas in numerically ascending order, the acceptance filter (1) uses a binary search algorithm, in which a number and identifier arranged approximately in the middle of a search range comprising the stored numbers and identifiers are compared with a received identifier and the number of the receiving user (2, 3, 4) and, depending on the result of the comparison, a new search range is defined above or below the previous search range as a new search range, while these comparisons and new search range divisions are repeated until a match is found during a comparison, which means that the searched-for identifier has been found for the receiving user (2, 3, 4).

5. An acceptance filter as claimed in one of claims 1 to 4, characterized in that the identifiers exhibit various formats and in that a comparison of a received identifier is performed only with such locally stored identifiers as exhibit the same format as the received identifier, while the allocated user (2, 3, 4) that has received a message with an identifier signals the format thereof to the acceptance filter.

6. An acceptance filter as claimed in one of claims 1 to 5, characterized in that some of the locally stored identifiers are stored individually and in that others are stored in the form of a numerical range.

7. An acceptance filter as claimed in claim 6, characterized in that a received identifier is firstly compared with the individually stored identifiers and then with the identifier ranges.

8. An acceptance filter as claimed in one of claims 1 to 7, characterized in that, if a plurality of allocated users (2, 3, 4) indicate the arrival of new messages with identifiers at the same time, filtering thereof by the acceptance filter (1) is performed in the order of the numbers of the allocated users (2, 3, 4).

9. An acceptance filter as claimed in claim 2 or 3, characterized in that the identifier memory (6) is configured as a look-up table and takes the form of a read-only memory or as a volatile memory loadable via the data bus.

10. An acceptance filter as claimed in one of claims 1 to 9, characterized in that the data bus complies with the CAN specification.
